(19) United States
(12) Patent Application Publication
(10) Pub. No.: US 2013/0200293 A1
(43) Pub. Date: Aug. 8, 2013

(54) LA(FE,SI)13-BASED MULTI-INTERSTITIAL ATOM HYDRIDE MAGNETIC REFRIGERATION MATERIAL WITH HIGH TEMPERATURE STABILITY AND LARGE MAGNETIC ENTROPY CHANGE AND PREPARATION METHOD THEREOF

(71) Applicants: Jinliang Zhao, Beijing (CN); Baogen Shen, Beijing (CN); Fengxia Hu, Beijing (CN); Jun Shen, Beijing (CN); Yangxian Li, Beijing (CN); Jirong Sun, Beijing (CN); Huayang Gong, Yichang (CN); Jianxiong Yin, Yichang (CN); Xiaohuan Wang, Yichang (CN)

(72) Inventors: Jinliang Zhao, Beijing (CN); Baogen Shen, Beijing (CN); Fengxia Hu, Beijing (CN); Jun Shen, Beijing (CN); Yangxian Li, Beijing (CN); Jirong Sun, Beijing (CN); Huayang Gong, Yichang (CN); Jianxiong Yin, Yichang (CN); Xiaohuan Wang, Yichang (CN)

(73) Assignees: HUBEI QUANYANG MAGNETIC MATERIALS MANUFACTURING CO., LTD., Yichang, Hubei (CN); INSTITUTE OF PHYSICS CHINESE ACADEMY OF SCIENCES, Zhongguancun, Beijing (CN)

(21) Appl. No.: 13/514,960

(22) PCT Filed: Dec. 1, 2010
(86) PCT No.: PCT/CN2010/001936

§ 371 Date: Sep. 17, 2012

(30) Foreign Application Priority Data
Dec. 11, 2009 (CN) 200910242322.6

(51) Int. Cl. H01F 1/01

(52) U.S. Cl. CPC H01F 1/012
USPC 252/62.51 R

(57) ABSTRACT

The invention discloses a La(Fe,Si)₁₃-based hydride magnetic refrigeration material comprising multiple interstitial atoms and showing a high-temperature stability and a large magnetic entropy change and the method for preparing the same. By reintroducing interstitial hydrogen atoms into an interstitial master alloy La₁₋ₐRₐFe_{13-b}Si_{b}X_{c} through a hydrogen absorption process, a compound with a chemical formula of La₁₋ₐRₐFe_{13-b}Si_{b}X_{c}H_{d} and a cubic NaZn₁₃-type structure is prepared, wherein R is one or a combination of more than one rare-earth element, X is one or more C, B and the like or their combinations. A desired amount of hydrogen is obtained through a single hydrogen absorption process by means of controlling the hydrogen pressure, temperature and period in the process of hydrogen absorption. The compound can be stable under normal pressure, at a temperature of room temperature to 350° C., that is, the hydrogen atoms can still exist stably in the interstices. The Curie temperature of the compound can be adjusted continuously with a wide range of 180K to 360K by changing its composition. The magnetic entropy change that is more than 2 folds of that of Gd can be obtained around room temperature, and the magnetic hysteresis loss vanishes. In view of the above, this material is a desired magnetic refrigeration material applied at room temperature.

### TECHNICAL FIELD

The invention relates to a magnetic material, especially a La(Fe,Si)₁₃-based hydride magnetic refrigeration material comprising multiple interstitial atoms and showing a high-temperature stability and a large magnetic entropy change. The invention also relates to a method for preparing the above magnetic refrigeration material.

### BACKGROUND ART

Magnetic refrigeration is an environment friendly refrigeration technology. Compared with the traditional refrigeration technologies relying on compression and expansion of gas, magnetic refrigeration is carried out by utilizing magnetic materials as the refrigeration working substance, which neither has a destructive effect on the atmospheric ozonosphere nor has the greenhouse effect. Moreover, since the magnetic working substance has a higher magnetic entropy density than those of gases, a refrigeration device can be manufactured in a more compact arrangement. In addition, magnetic refrigeration only relies on a desired magnetic field provided by an electromagnet, a superconductor or a permanent magnet, requires no compressor, and does not involve any abrasion issue in the moving parts. As a result, magnetic refrigeration has minor mechanical vibration and noise, higher reliability, and longer lifetime. In terms of the thermal efficiency, 30%˜60% of Carnot cycle can be achieved by magnetic refrigeration, whereas only 5%˜10% can generally be achieved by a refrigeration cycle relying on compression and expand of gas. Therefore, the magnetic refrigeration technology possesses a good application prospect, and known as a novel high-tech environment friendly refrigeration technology. Accordingly, the magnetic refrigeration technology, especially the magnetic refrigeration technology applied at room temperature, has attracted great attention of worldwide research institutions and industrial departments due to its huge potential application market in the industries such as household refrigerators, household air-conditioners, central air-conditioners, food refrigeration systems used in supermarkets, and the like.

The magnetocaloric properties of magnetic refrigeration working substance mainly include magnetic entropy change, adiabatic temperature change, specific heat, thermal conductivity, and the like. Among others, the magnetic entropy change and adiabatic temperature change are used to characterize the magnetocaloric effect of magnetic refrigeration materials. Because the magnetic entropy change is easier to be measured accurately than the adiabatic temperature change, the magnetic entropy change is more commonly used for characterizing the magnetocaloric effect of magnetic refrigeration materials. Moreover, the magnetocaloric effect (magnetic entropy change, adiabatic temperature change) of a magnetic refrigeration material is one of the key factors that restrict the refrigeration efficiency of a magnetic refrigerator. Therefore, discovery of a magnetic refrigeration material which has a large magnetic entropy change and a Curie point within the range of room temperatures becomes a research focus all over the world.

In 1997, Gschneidner and Pecharsky, from Ames Laboratory, USA, discovered that Gd₅(SiₓGe₁₋ₓ)₄ alloy (U.S. Pat. No. 5,743,095) shows a great magnetocaloric effect. Its magnetic entropy change reaches about 2 fold of that of Gd around room temperature. Such a large magnetic entropy change of this material comes from a first-order magnetic phase transition. Compared with a second-order magnetic phase transition, the magnetic entropy changes of the materials that have experienced first-order phase transitions are normally within a narrower temperature range around the phase transition point, and show higher magnetic entropy change values based on the Maxwell's equation. However, because these materials require highly purified raw materials such as rare earth and the like, they are very expensive and a dramatic magnetic hysteresis loss is caused. As a result, these disadvantages restrict their practical applications. Therefore, during the process of exploring a novel magnetic refrigeration material, it is very important to seek for a first-order transition material with a small hysteresis loss and a large magnetic entropy change.

Among the known rare-earth intermetallic compounds, the intermetallic compounds with a NaZn₁₃-type cubic structure, as a member of rare earth-transition family, have the highest 3d metal contents and the high symmetry of their structures, so that they have excellent soft magnetic properties and highly saturated magnetization. As for a rare earth-iron-based compound with a NaZn₁₃-type cubic structure, because of the positive formation heat between the rare earth and the iron, RFe₁₃ is not present, and the elements Al, Si and the like are required to be added so as to achieve a stable phase by reducing formation enthalpy.

Patent CN1450190A discloses a NaZn₁₃-type rare earth-iron-silicon(R—Fe—Si)-based intermetallic compound, and a method for producing a metallic interstitial compound with a low C content by directly smelting and annealing. By way of changing the content of C atoms in the alloy, the Curie temperature can be adjusted within a certain range. However, as the interstitial C atoms increase, more and more α-Fe appears in the alloy, which causes a lowered magnetic entropy change and a reduced refrigeration capacity. As for the interstitial compound produced from a master alloy without C through aeration and deaeration processes, the Curie temperature can be adjusted in a wide range and only a tiny reduction of the magnetic entropy change occurs. However, when the temperature exceeds 150° C., the interstitial hydrogen will be removed from the alloy, so that this material has a poorer performance, and the uniformity of the interstitial hydride produced from such a master alloy cannot be ensured. In addition, according to the preparation method disclosed in this patent, the aeration temperature is required to be within a range of 0 to 800° C., the pressure is within a range of 0.5 to 10 atm., and the aeration period is within 0 to 100 hours, therefore higher requirements for the hydrogen absorbing equipments and the ambient environment are raised. Moreover, the method involving hydrogen absorption followed by hydrogen discharge not only complicates the technical process, but also results in the presence of an impurity phase α-Fe.

To sum up, all the existing materials cannot satisfy the following requirements for a magnetic refrigeration material applied in practice simultaneously: possessing a highly stabilized performance, having the Curie temperature adjustable in a wide range around room temperature by changing the composition, maintaining a large magnetic entropy change, and causing a minor magnetic hysteresis loss.

### CONTENTS OF INVENTION

An object of the invention is to provide a La(Fe,Si)₁₃-based hydride magnetic refrigeration material comprising multiple interstitial atoms and showing a stable performance and a large magnetic entropy change.

Another object of the invention is to provide a method for preparing the above hydride magnetic refrigeration material comprising multiple interstitial atoms.

For achieving the above objects, first, a La(Fe,Si)₁₃-based interstitial master alloy with a formula of La₁₋ₐRₐFe_{13-b}Si_{b}X_{c} is prepared, and then interstitial hydrogen atoms are introduced into the interstitial master alloy La₁₋ₐRₐFe_{13-b}Si_{b}X_{c}, so as to overcome the difficulties in keeping the stability of hydrogen in the alloy at a high temperature, possessing the Curie temperature adjustable continuously in a wide range, maintaining a large magnetic entropy change, and reducing the magnetic hysteresis loss simultaneously. As a result, such a La(Fe,Si)₁₃-based hydride magnetic refrigeration material comprising multiple interstitial atoms that has a stable performance (structure), the Curie temperature adjustable in a wide range around room temperature, a small magnetic hysteresis loss, and a larger magnetic entropy change superior to that of Gd is obtained. By way of strictly controlling the hydrogen pressure and the absorption period in the preparation process, the amount of the interstitial hydrogen atoms in the final product La₁₋ₐRₐFe_{13-b}Si_{b}X_{c}H_{d} interstitial alloy can be controlled accurately.

The objects of the invention are achieved by the following technical solutions.

In one aspect, the invention provides a La(Fe,Si)₁₃-based hydride magnetic refrigeration material comprising multiple interstitial atoms and showing a high-temperature stability and a large magnetic entropy change, characterized in that, the material has a chemical formula of La₁₋ₐRₐFe_{13-b}Si_{b}X_{c}H_{d}, and has a cubic NaZn₁₃-type structure, wherein:

R is one of or any combination of the following rare-earth elements Ce, Pr, Nd, Sm, Eu, Gd, Tb, Dy, Ho, Er, Tm, Yb, Lu, Y, and Sc which satisfy the requirement for a,

a is in the ranges shown as follows:
if R is Ce, then 0<a≦0.9;
if R is Pr, Nd, then 0<a≦0.7;
if R is Sm, Eu, Gd, Tb, Dy, Ho, Er, Tm, Yb, Lu, Y, Sc, then 0<a≦0.5;

b is in a range of 0<b≦3.0;

X is one of or any combination of the elements C, B, Li, and Be which satisfy the requirement for c,

c is in a range of 0<c≦0.5;
d is in a range of 0<d≦3.0.

Preferably, with regard to the inventive La(Fe,Si)₁₃-based hydride magnetic refrigeration material comprising multiple interstitial atoms and showing a high-temperature stability and a large magnetic entropy change, hydrogen can still exist stably in the interstices in a condition of 0 to 350° C., and while magnetic field changes from 0 to 5 T, the magnetic entropy change value is 5 to 50 J/kgK, and the temperature range of phase transition is within 180-360K.

In another aspect, the invention provides a method for preparing the rare earth-iron-based compound magnetic refrigeration material comprising multiple interstitial atoms and showing a high-temperature stability and a large magnetic entropy change, which comprises the steps of:

i) preparing raw materials according to a chemical formula of La₁₋ₐRₐFe_{13-b}Si_{b}X_{c}, wherein R, X, a, b, and c are defined as above;

ii) charging an arc furnace with the raw materials prepared in step i), vacuumizing the furnace, washing the chamber of the furnace with highly purified argon followed by filling the chamber with the argon to a pressure of 0.5 to 1.5 atm., striking the arc, and turning and smelting each alloy ingot repeatedly for 1 to 6 times;

iii) annealing the alloy ingot smelted in step ii) in a vacuum under a condition of 1050 to 1350° C., followed by taking the alloy ingot out and quenching it rapidly in liquid nitrogen or ice water for cooling down, so as to prepare a single-phase, NaZn₁₃-type, La₁₋ₐRₐFe_{13-b}Si_{b}X_{c} interstitial master alloy sample;

iv) crashing the master alloy La₁₋ₐRₐFe_{13-b}Si_{b}X_{c} prepared in step iii) into particles or powder, placing the particles or powder in hydrogen for annealing, so as to synthesize the hydride La₁₋ₐRₐFe_{13-b}Si_{b}X_{c}H_{d} comprising multiple interstitial atoms, wherein the content d of the hydrogen in the alloy, as defined above, is controlled by adjusting the hydrogen pressure, annealing temperature, and annealing time.

Preferably, in the inventive method, the master alloy La₁₋ₐRₐFe_{13-b}Si_{b}X_{c} used for preparing La₁₋ₐRₐFe_{13-b}Si_{b}X_{c}H_{d} is a fresh master alloy.

Preferably, according to the method of the invention, in step i), the purities of the raw materials La, R, Fe, Si, and X are more than 99% by weight, preferably more than 99.9% by weight, more preferably more than 99.99% by weight, wherein La, R, Fe, Si and X are defined as above. Fe and X are introduced into the alloy in a form of individual element or Fe—X intermediate alloy.

Preferably, according to the method of the invention, in step ii), the smelting temperature is 1000° C.-2500° C., the vacuum pressure is lower than 2×10⁻⁵ Pa, and the argon has a purity of more than 99%.

Preferably, according to the method of the invention, in step iii), the vacuum pressure during the annealing process is lower than 1×10⁻³ Pa, and the annealing period is 1 day to 30 days.

Preferably, according to the method of the invention, in step iv), the hydrogen pressure is higher than 0 atm. and lower than or equal to 5 atm., and in the hydrogen, the annealing temperature is 0 to 350° C. and the annealing period is 1 minute to 1 day.

Preferably, according to the method of the invention, in step iv), the amount of the interstitial hydrogen atoms in the hydride comprising multiple interstitial atoms is determined using a PCT (Pressure-Concentration-Temperature) experimental analyzer.

Preferably, according to the method of the invention, in step iv), a desired amount of hydrogen is obtained through a single hydrogen absorption process.

Preferably, in step iv), the powder produced from the singe-phase sample is irregular powder with a particle size of less than 2 mm, and the hydrogen used for annealing has a purity of more than 99%.

Compared to the prior art, the present invention has the advantages shown as follows:

1) In the invention, first a La(Fe,Si)₁₃-based interstitial master alloy with a formula of La₁₋ₐRₐFe_{13-b}Si_{b}X_{c} is prepared, and then interstitial hydrogen atoms are introduced into the interstitial master alloy La₁₋ₐRₐFe_{13-b}Si_{b}X_{c}, so as to prepare a La(Fe,Si)₁₃-based compound magnetic refrigeration material comprising multiple interstitial atoms and showing a high-temperature stability and a large magnetic entropy change. Compared with the interstitial compound previously synthesized by absorbing hydrogen directly, this compound can maintain a stable performance at room temperature to 350° C., under normal pressure, i.e., hydrogen atoms can still exist in the interstices stably. Additionally, the Curie point of the compound can be continuously adjusted in a wide range of 180K˜360K by changing its composition. A large magnetic entropy change, which is more than two folds of that of Gd, can be achieved around room temperature. In view of the above, this compound is a desired magnetic refrigeration material used at room temperature.

2) The invention provides a method for preparing a La(Fe,Si)₁₃-based compound magnetic refrigeration material comprising multiple interstitial atoms and showing a high-temperature stability and a large magnetic entropy change. By this method, the amount of the interstitial atoms (N, H, and the like) in the master alloy can be controlled and measured more accurately, the temperature of gas absorption and the pressure are lowered, the process is simplified, and the resultant interstitial compound is more uniform. In addition, since the raw materials used in the invention comprises plenty of relatively cheaper elements such as Fe, etc. and is in an abundant amount, a significant advantage of low cost is achieved. Moreover, the present invention also has the advantages, such as involving a simple preparation process and suitable for the industrial production of the magnetic refrigeration material, and the like.

### DESCRIPTION OF DRAWINGS

FIG. 1 shows the X-ray diffraction (XRD) spectrum of Pr_{0.3}La_{0.7}Fe_{11.5}Si_{1.5}C_{0.2} prepared in Example 1 of the invention at room temperature, wherein, the abscissa indicates the diffraction angle, and the ordinate indicates the diffraction intensity;

FIG. 2 shows the magnetization-temperature (M-T) curves of Pr_{0.3}La_{0.7}Fe_{11.5}Si_{1.5}C_{0.2} prepared in Example 1 of the invention in a magnetic field of 100 Oe, wherein the abscissa indicates the temperature, and the ordinate indicates the magnetization intensity, and in the curves:

“——” represents the thermomagnetic curve of Pr_{0.3}La_{0.7}Fe_{11.5}Si_{1.5}C_{0.2} in the process of raising the temperature, and

“—◯—” represents the thermomagnetic curve of Pr_{0.3}La_{0.7}Fe_{11.5}Si_{1.5}C_{0.2} in the process of lowering the temperature;

FIG. 3 shows the magnetization curves of Pr_{0.3}La_{0.7}Fe_{11.5}Si_{1.5}C_{0.2} prepared in Example 1 of the invention, wherein the abscissa indicates the magnetic induction intensity, and the ordinate indicates the magnetization intensity, and in the curves:

“——” represents the isothermal magnetization curve of Pr_{0.3}La_{0.7}Fe_{11.5}Si_{1.5}C_{0.2} in the process of increasing the field intensity, and

“—◯—” represents the isothermal magnetization curve of Pr_{0.3}La_{0.7}Fe_{11.5}Si_{1.5}C_{0.2} n the process of decreasing the field intensity;

FIG. 4 shows the curves of magnetic entropy change vs. temperature of Pr_{0.3}La_{0.7}Fe_{11.5}Si_{1.5}C_{0.2} prepared in Example 1 of the invention in the magnetic fields of 1 T, 2 T, 3 T, 4 T, and 5 T, wherein the abscissa indicates the temperature, and the ordinate indicates the magnetic entropy change, and in the curves:

“—▪—” represents the isothermal magnetic entropy change-temperature curve of Pr_{0.3}La_{0.7}Fe_{11.5}Si_{1.5}C_{0.2} in a magnetic field of 1 T,

“——” represents the isothermal magnetic entropy change-temperature curve of Pr_{0.3}La_{0.7}Fe_{11.5}Si_{1.5}C_{0.2} in a magnetic field of 2 T,

“—▴—” represents the isothermal magnetic entropy change-temperature curve of Pr_{0.3}La_{0.7}Fe_{11.5}Si_{1.5}C_{0.2} in a magnetic field of 3 T,

“—▾—” represents the isothermal magnetic entropy change-temperature curve of Pr_{0.3}La_{0.7}Fe_{11.5}Si_{1.5}C_{0.2} in a magnetic field of 4 T, and

“—♦—” represents the isothermal magnetic entropy change-temperature curve of Pr_{0.3}La_{0.7}Fe_{11.5}Si_{1.5}C_{0.2} in a magnetic field of 5 T;

FIG. 5 shows the curve of the magnetic hysteresis loss vs. temperature of Pr_{0.3}La_{0.7}Fe_{11.5}Si_{1.5}C_{0.2} prepared in Example 1 of the invention in a magnetic field of 5 T, wherein the abscissa indicates the temperature, the ordinate indicates the magnetic hysteresis loss, and in the curves:

“——” represents the magnetic hysteresis loss-temperature curve of Pr_{0.3}La_{0.7}Fe_{11.5}Si_{1.5}C_{0.2} in a magnetic field of 5 T;

FIG. 6 shows the hydrogen absorption and discharge curves of Pr_{0.3}La_{0.7}Fe_{11.5}Si_{1.5}C_{0.2} prepared in Example 1 of the invention and of Pr_{0.3}La_{0.7}Fe_{11.5}Si_{1.5} prepared in Comparative Example 2 at 350° C., and in the curves:

“——” represents the curve of hydrogen pressure-hydrogen percentage by mass in the sample of Pr_{0.3}La_{0.7}Fe_{11.5}Si_{1.5}C_{0.2} in the process of hydrogen absorption at 350° C.,

“—◯—” represents the curve of hydrogen pressure-hydrogen percentage by mass in the sample of Pr_{0.3}La_{0.7}Fe_{11.5}Si_{1.5}C_{0.2} in the process of hydrogen discharge at 350° C.,

“—▪—” represents the curve of hydrogen pressure-hydrogen percentage by mass in the sample of Pr_{0.3}La_{0.7}Fe_{11.5}Si_{1.5} in the process of hydrogen absorption at 350° C., and represents the curve of hydrogen pressure-hydrogen percentage by mass in the sample of Pr_{0.3}La_{0.7}Fe_{11.5}Si_{1.5} in the process of hydrogen discharge at 350° C.;

FIG. 7 shows the M-T curves of Pr_{0.3}La_{0.7}Fe_{11.5}Si_{1.5}C_{0.2}H_{0.6} prepared in Example 2 of the invention in a magnetic field of 100 Oe, wherein the abscissa indicates the temperature, the ordinate indicates the magnetization intensity, and in the curves:

“——” represents the thermomagnetic curve of Pr_{0.3}La_{0.7}Fe_{11.5}Si_{1.5}C_{0.2}H_{0.6} in the process of raising the temperature, and

“—◯—” represents the thermomagnetic curve of Pr_{0.3}La_{0.7}Fe_{11.5}Si_{1.5}C_{0.2}H_{0.6} in the process of lowering the temperature;

FIG. 8 shows the magnetization curves of Pr_{0.3}La_{0.7}Fe_{11.5}Si_{1.5}C_{0.2}H_{0.6} prepared in Example 2 of the invention, wherein the abscissa indicates magnetic induction intensity, and the ordinate indicates the magnetization intensity, and in the curves:

“——” represents the isothermal magnetization curve of Pr_{0.3}La_{0.7}Fe_{11.5}Si_{1.5}C_{0.2}H_{0.6} in the process of increasing the field intensity, and

“—◯'” represents the isothermal magnetization curve of Pr_{0.3}La_{0.7}Fe_{11.5}Si_{1.5}C_{0.2}H_{0.6} in the process of decreasing the field intensity;

FIG. 9 shows the curves of magnetic entropy change vs. temperature of Pr_{0.3}La_{0.7}Fe_{11.5}Si_{1.5}C_{0.2}H_{0.6} prepared in Example 2 of the invention in the magnetic fields of 1 T, 2 T, 3 T, 4 T, and 5 T, wherein the abscissa indicates the temperature, and the ordinate indicates the magnetic entropy change, and in the curves:

“—▪—” represents the isothermal magnetic entropy change-temperature curve of Pr_{0.3}La_{0.7}Fe_{11.5}Si_{1.5}C_{0.2}H_{0.6} in a magnetic field of 1 T,

“——” represents the isothermal magnetic entropy change-temperature curve of Pr_{0.3}La_{0.7}Fe_{11.5}Si_{1.5}C_{0.2}H_{0.6} in a magnetic field of 2 T,

“—▴—” represents the isothermal magnetic entropy change-temperature curve of Pr_{0.3}La_{0.7}Fe_{11.5}Si_{1.5}C_{0.2}H_{0.6} in a magnetic field of 3 T,

“—▾—” represents the isothermal magnetic entropy change-temperature curve of Pr_{0.3}La_{0.7}Fe_{11.5}Si_{1.5}C_{0.2}H_{0.6} in a magnetic field of 4 T, and

“—♦—” represents the isothermal magnetic entropy change-temperature curve of Pr_{0.3}La_{0.7}Fe_{11.5}Si_{1.5}C_{0.2}H_{0.6} in a magnetic field of 5 T;

FIG. 10 shows the M-T curves of Pr_{0.3}La_{0.7}Fe_{11.5}Si_{1.5}C_{0.2}H_{1.2}prepared in Example 2 of the invention in a magnetic field of 100 Oe, wherein the abscissa indicates the temperature, the ordinate indicates the magnetization intensity, and in the curves:

“——” represents the thermomagnetic curve of Pr_{0.3}La_{0.7}Fe_{11.5}Si_{1.5}C_{0.2}H_{1.2} n the process of raising the temperature, and

“—◯—” represents the thermomagnetic curve of Pr_{0.3}La_{0.7}Fe_{11.5}Si_{1.5}C_{0.2}H_{1.2} n the process of lowering the temperature;

FIG. 11 shows the magnetization curves of Pr_{0.3}La_{0.7}Fe_{11.5}Si_{1.5}C_{0.2}H_{1.2} prepared in Example 2 of the invention, wherein the abscissa indicates the magnetic induction intensity, and ordinate indicates the magnetization intensity, and in the curves:

“——” represents the isothermal magnetization curve of Pr_{0.3}La_{0.7}Fe_{11.5}Si_{1.5}C_{0.2}H_{1.2} in the process of increasing the field intensity, and

“—◯—” represents the isothermal magnetization curve of Pr_{0.3}La_{0.7}Fe_{11.5}Si_{1.5}C_{0.2}H_{1.2} in the process of decreasing the field intensity;

FIG. 12 shows the curves of magnetic entropy change vs. temperature of Pr_{0.3}La_{0,7}Fe_{11.5}Si_{1.5}C_{0.2}H_{1.2} prepared in Example 2 of the invention in the magnetic fields of 1 T, 2 T, 3 T, 4 T, and 5 T, wherein the abscissa indicates the temperature, and the ordinate indicates the magnetic entropy change, and in the curves:

“—▪—” represents the isothermal magnetic entropy change-temperature curve of Pr_{0.3}La_{0.7}Fe_{11.5}Si_{1.5}C_{0.2}H_{1.2} in a magnetic field of 1 T,

“——” represents the isothermal magnetic entropy change-temperature curve of Pr_{0.3}La_{0.7}Fe_{11.5}Si_{1.5}C_{0.2}H_{1.2} in a magnetic field of 2 T,

“—▴—” represents the isothermal magnetic entropy change-temperature curve of Pr_{0.3}La_{0.7}Fe_{11.5}Si_{1.5}C_{0.2}H_{1.2} in a magnetic field of 3 T,

“—▾—” represents the isothermal magnetic entropy change-temperature curve of Pr_{0.3}La_{0.7}Fe_{11.5}Si_{1.5}C_{0.2}H_{1.2} in a magnetic field of 4 T, and

“—♦—” represents the isothermal magnetic entropy change-temperature curve of Pr_{0.3}La_{0.7}Fe_{11.5}Si_{1.5}C_{0.2}H_{1.2} in a magnetic field of 5 T.

### SPECIFIC MODE FOR CARRYING OUT THE INVENTION

The invention is further described by referring to the specific Examples. A person skilled in the art shall understand that these Examples are provided for the purpose of illustrating the invention only and are not intended to restrict the scope of the invention by any means.

### EXAMPLE 1

### Preparation of Interstitial Master Alloy Pr_{0.3}La_{0.7}Fe_{11.5}Si_{1.5}C_{0.2}

An interstitial master alloy with a chemical formula of Pr_{0.3}La_{0.7}Fe_{11.5}Si_{1.5}C_{0.2} was prepared according to the following process:

i) The raw materials i.e. commercial rare-earth metals La, Pr with a purity of higher than 99.9% by weight (manufacturer: Hunan Shenghua Rare-earth Metal Material Co., Ltd.), Fe, Fe—C intermediate alloy (the carbon content was 4.03% by weight) and Si were weighted and mixed according to the chemical formula Pr_{0.3}La_{0.7}Fe_{11.5}Si_{1.5}C_{0.2}. In this process, an excess of 5% (atom percentage) of the rare-earth metals La and Pr was added to compensate the loss caused by volatilization and burning during the smelting.

ii) An arc furnace was charged with the raw materials prepared in step i), vacuumized to a pressure of 2×10⁻⁵ Pa or lower and washed with regular high-purity argon for once or twice. Then a turning and smelting process was carried out by a normal method and repeated for 3 to 6 times under the protection of high-purity argon at a pressure of 1 atm. The smelting temperature was raised until the material was melted.

iii) An ingot alloy was obtained by cooling down in a copper crucible. After wrapped with molybdenum foil and sealed in a vacuumized quartz tube, the ingot alloy was annealed at 1120° C. for two weeks followed by being quenched in liquid nitrogen. As a result, this series of compound samples were obtained.

The X-ray diffraction spectrum of a sample at room temperature was measured using a Cu-target X-ray diffractometer (manufactured by Rigaku Co., Model: RINT2400). The result showed that the sample was a NaZn₁₃-type cubic crystal structure. It is shown in FIG. 1 that the XRD spectrum of the interstitial master alloy Pr_{0.3}La_{0.7}Fe_{11.5}Si_{1.5}C_{0.2} at room temperature has an excellent single-phase property.

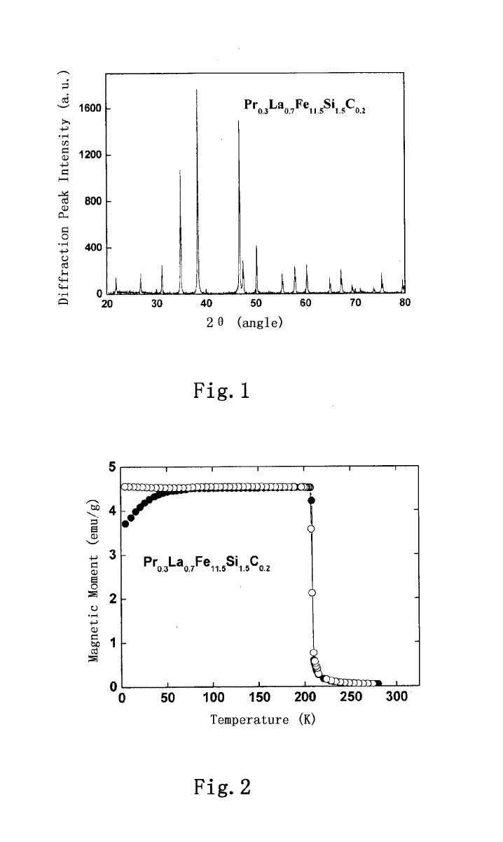

The thermomagnetic curve (M-T) of Pr_{0.3}La_{0.7}Fe_{11.5}Si_{1.5}C_{0.2}, i.e. the compound of this Example, was measured using a superconducting quantum magnetometer (SQUID, Trade name: superconducting quantum interference magnetometer, Manufacturer: Quantum Design, USA, Model: MPMS-7). As shown in FIG. 2, it can be determined from the M-T curve that T_{c} at the Curie point is 208K.

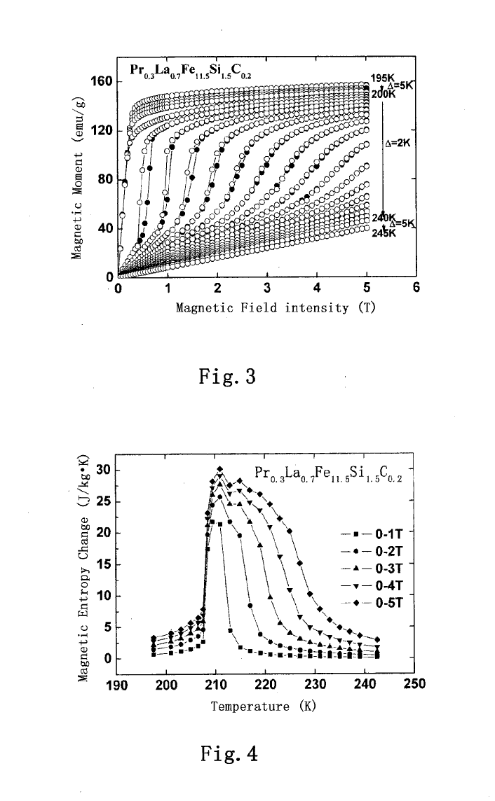

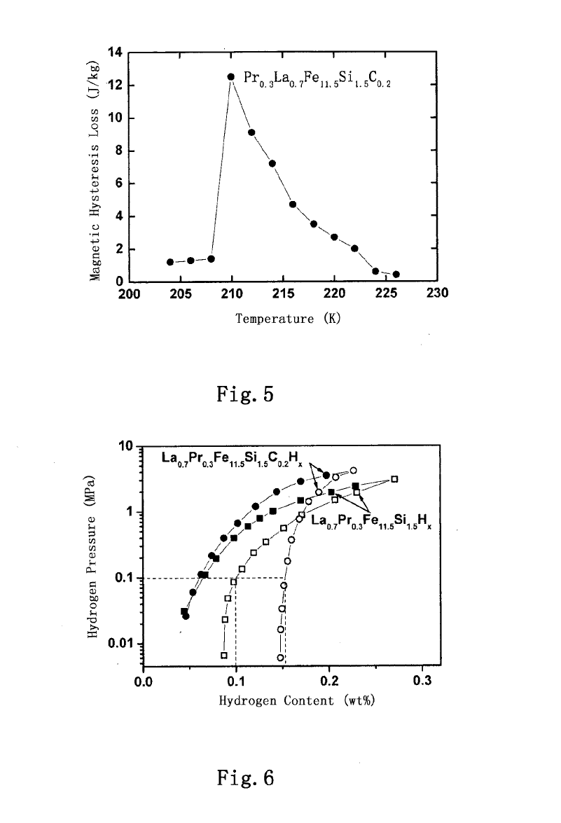

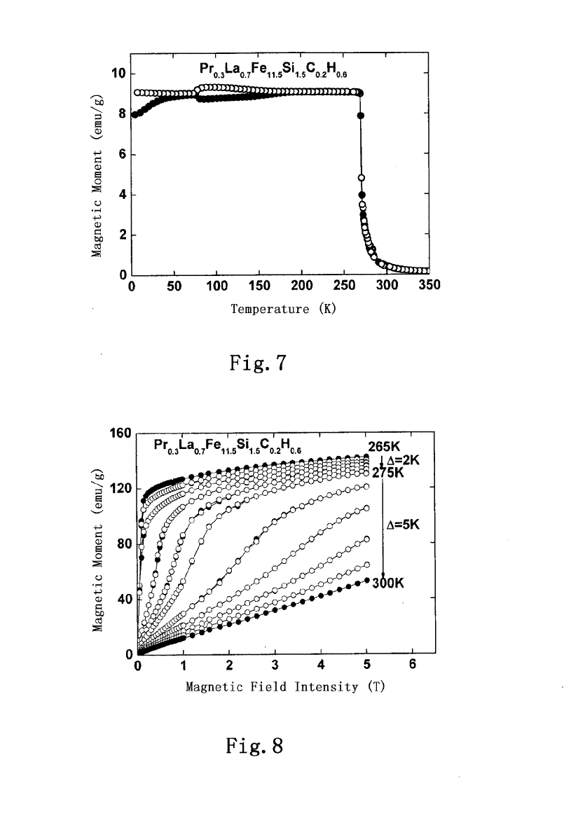

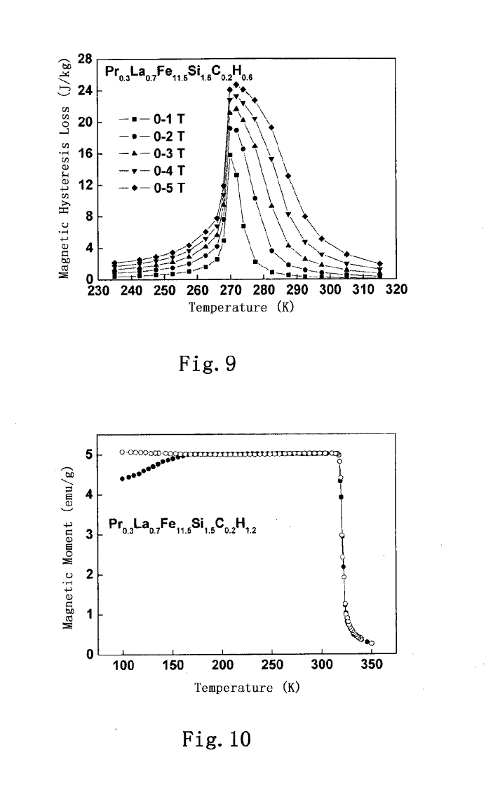

The isothermal magnetization curve of this interstitial compound was measured using SQUID around the Curie temperature, as shown in FIG. 3.

On the basis of the Maxwell's equation, the magnetic entropy change can be calculated according to the isothermal magnetization curve.

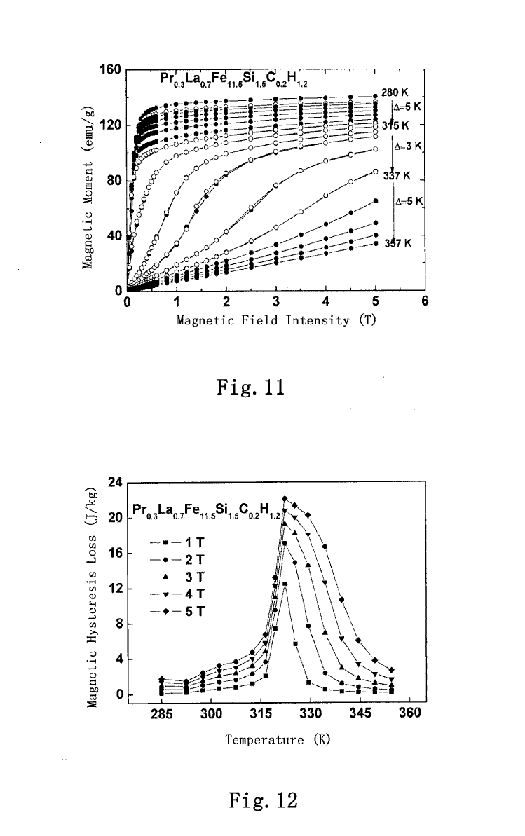

The magnetic entropy change-temperature (-ΔS-T) curves around the Curie temperature of the interstitial master alloy Pr_{0.3}La_{0.7}Fe_{11.5}Si_{1.5}C_{0.2} prepared in this Example were shown in FIG. 4, in which it is shown that a large magnetic entropy change occurred at T_{c}, and the magnetic entropy change was up to 30.1 J/kg·K while the magnetic field change was 0 to 5 T. The magnetic hysteresis loss-temperature curve of the interstitial master alloy Pr_{0.3}La_{0.7}Fe_{11.5}Si_{1.5}C_{0.2} is shown in FIG. 5, in which it is shown that a relatively large magnetic hysteresis loss was present.

### COMPARATIVE EXAMPLE 1

### Rare Earth Metal Gd

A typical room-temperature magnetic refrigeration material Gd (with a purity of 99.9% by weight, manufacturer: Hunan Shenghua Rare-earth Metal Material Co., Ltd.) was chosen and used in the comparative Example. It was found that under a magnetic field of 100 Oe measured using a superconducting quantum magnetometer (SQUID, trade name: superconducting quantum interference magnetometer, manufacturer: Quantum Design, USA, Model: MPMS-7), the Curie temperature of Gd was 293K, and while the magnetic field change was 0 to 5 T, the magnetic entropy change of Gd was 9.8 J/kg·K at the Curie temperature.

### COMPARATIVE EXAMPLE 2

### Preparation of Pr_{0.3}La_{0.7}Fe_{11.5}Si_{1.5} Alloy

An alloy with a chemical formula of Pr_{0.3}La_{0.7}Fe_{11.5}Si_{1.5} was prepared according to the following process:

i) The raw materials i.e. commercial rare-earth metals La, Pr with a purity of higher than 99.9% by weight (manufacturer: Hunan Shenghua Rare-earth Metal Material Co., Ltd.), Fe and Si were weighted and mixed according to the chemical formula Pr_{0.3}La_{0.7}Fe_{11.5}Si_{1.5}. In this process, an excess of 5% (atom percentage) of the rare-earth metals La and Pr was added to compensate the loss caused by volatilization and burning during the smelting.

ii) An arc furnace was charged with the raw materials prepared in step i), vacuumized to a pressure of 2×0⁻⁵ Pa or lower and washed with regular high-purity argon for once or twice. Then a turning and smelting process was carried out by a normal method and repeated for 3 to 6 times under the protection of high-purity argon at a pressure of 1 atm. The smelting temperature was raised until the material was melted.

iii) An ingot alloy was obtained by cooling down in a copper crucible. After wrapped with molybdenum foil and sealed in a vacuumized quartz tube, the ingot alloy was annealed at 1120° C. for two weeks followed by being quenched in liquid nitrogen. As a result, this series of compound Pr_{0.3}La_{0.7}Fe_{11.5}Si_{1.5} samples were obtained.

### EXAMPLE 2

### Preparation of Pr_{0.3}La_{0.7}Fe_{11.5}Si_{1.5}C_{0.2}H_{0.6} and Pr_{0.3}La_{0.7}Fe_{11.5}Si_{1.5}C_{0.2}H_{1.2}

Compounds with chemical formulas of Pr_{0.3}La_{0.7}Fe_{11.5}Si_{1.5}C_{0.2}H_{0.6} and Pr_{0.3}La_{0.7}Fe_{11.5}Si_{1.5}C_{0.2}H_{1.2} were prepared by introducing H atoms into Pr_{0.3}La_{0.7}Fe_{11.5}Si_{1.5}C_{0.2} according to the process shown as follow.

The fresh interstitial master alloy Pr_{0.3}La_{0.5}Si_{1.5}C_{0.2} prepared in Example 1 was crashed into particles and place into a high-pressure container which had been vacuumized to 2×10⁻⁵ Pa or lower. High-purity H₂ was introduced into the high-pressure container at 350° C. under the pressures of 1.0 and 1.5 atm., respectively. The gas absorbing period was 5 hours and 2 hours, respectively. Then, the high-pressure container was placed into water at room temperature (20° C.), and at the same time, the remaining hydrogen in the high-pressure container was removed by a mechanical pump, and the high-pressure container was cooled down to room temperature. Based on the analysis with a PCT (manufacturer: General Research Institute for Nonferrous Metals, Beijing) experimental analyzer and the weighting using a balance, the interstitial compounds which had H in the contents of about 0.6 and 1.2, respectively were obtained.

In this process, the curves of hydrogen content in the sample vs. hydrogen pressure during the hydrogen absorption and discharge process was obtained and shown in FIG. 6. From this figure, it was indicated that adding of carbon dramatically improved the hydrogen content under normal pressure, i.e. the hydrogen content was increased from 0.098% to 0.153% by weight. Additionally, the hydrogen absorption was performed at 350° C., which ensured that the Pr_{0.3}La_{0.7}Fe_{11.5}Si_{1.5}C_{0.2}Hₓ compound was stable in a relatively wide range around room temperature.

The thermomagnetic curves (M-T) of Pr_{0.3}La_{0.7}Fe_{11.5}Si_{1.5}C_{0.2}H_{0.6} and Pr_{0.3}La_{0.7}Fe_{11.5}Si_{1.5}C_{0.2}H_{1.2} in this Example were obtained using a superconducting quantum magnetometer (SQUID, trade name: superconductive quantum interference magnetometer, manufacturer: Quantum Design, USA, Model: MPMS-7), as shown in FIGS. 7 and 10. From the M-T curves, it can be determined that the Curie temperature T_{c} was 270K and 321K for Pr_{0.3}La_{0.7}Fe_{11.5}Si_{1.5}C_{0.2}H_{0.6} and Pr_{0.3}La_{0.7}Fe_{11.5}Si_{1.5}C_{0.2}H_{1.2}, respectively, which deviate from the Tc of the interstitial master alloy Pr_{0.3}La_{0.7}Fe_{11.5}Si_{1.5}C_{0.2} by 62 K and 113 K, respectively.

The isothermal magnetization curves of these interstitial compounds were measured using SQUID around the Curie temperature, as shown in FIGS. 8 and 11.

The magnetic entropy change-temperature (-ΔS-T) curves around the Curie temperature of Pr_{0.3}La_{0.7}Fe_{11.5}Si_{1.5}C_{0.2}H_{0.6} and Pr_{0.3}La_{0.7}Fe_{11.5}Si_{1.5}C_{0.2}H_{1.2} prepared in this Example were shown in FIGS. 9 and 12. From these figures, it was indicated that very large magnetic entropy changes occurred at T_{c}. While the magnetic field change was 0 to 5 T, the magnetic entropy changes reached 24.7 J/kg·K and 22.1 J/kg·K respectively, i.e. both are more than 2 folds of that of the rare earth metal Gd. In addition, the magnetic hysteresis loss was proportional to the area surrounded by the magnetic field intensity increasing and decreasing curves at the same temperature. From FIG. 3, it could be determined that Pr_{0.3}La_{0.7}Fe_{11.5}Si_{1.5}C_{1.2} had a very large area surrounded by the magnetic field intensity increasing and decreasing curves at the same temperature before hydrogen absorption, that is, a very large hysteresis loss existed, as shown in FIG. 5. From FIG. 8 and FIG. 11, it could be seen that after hydrogen absorption, Pr_{0.3}La_{0.7}Fe_{11.5}Si_{1.5}C_{0.2}H_{0.6} and Pr_{0.3}La_{0.5}Fe_{11.5}Si_{1.5}C_{0.2}H_{1.2} had the areas surrounded by the magnetic field intensity increasing and decreasing curves at the same temperature which were close to zero. Therefore, compared with Pr_{0.3}La_{0.5}Fe_{11.5}Si_{1.5}C_{0.2}, the magnetic hysteresis losses of Pr_{0.3}La_{0.7}Fe_{11.5}Si_{1.5}C_{0.2}H_{0.6} and Pr_{0.3}La_{0.7}Fe_{11.5}Si_{1.5}C_{0.2}H_{1.2} nearly vanished, which was beneficial to their practical application. Because the hydrogen absorption was carried out at 350° C. under normal pressure, the sample could be stable in a relatively large temperature range. As shown in FIG. 6, when normal pressure was achieve by deaeration, a large amount of hydrogen was still present in the samples of Pr_{0.3}La_{0.7}Fe_{11.5}Si_{1.5}C_{0.2}Hₓ, and the content of hydrogen was increased more significantly compared with Pr_{0.3}La_{0.7}Fe_{11.5}Si_{1.5}Hₓ.

The invention has been described in detail by referring to the specific embodiments above. A person skilled in the field shall understand that the above specific embodiments should not be interpreted to restrict the scope of the invention. Therefore, without deviating from the spirit and extent of the invention, the embodiments of the invention can be altered and modified.

1. A La(Fe,Si)₁₃-based hydride magnetic refrigeration material comprising multiple interstitial atoms and showing a high-temperature stability and a large magnetic entropy change, wherein, the material has a chemical formula of La₁₋ₐRₐFe_{13-b}Si_{b}X_{c}H_{d}, and has a cubic NaZn13-type structure, wherein:
R is one of or any combination of the following rare-earth elements Ce, Pr, Nd, Sm, Eu, Gd, Tb, Dy, Ho, Er, Tm, Yb, Lu, Y, and Sc which satisfy the requirement for a,
a is in the ranges shown as follows:
if R is Ce, then 0<a≦0.9;
if R is Pr, Nd, then 0<a≦0.7;
if R is Sm, Eu, Gd, Tb, Dy, Ho, Er, Tm, Yb, Lu, Y, Sc, then 0<a≦0.5;
b is in a range of 0<b≦3.0;
X is one of or any combination of the elements C, B, Li, and Be which satisfy the requirement for c,
c is in a range of 0<c≦0.5; and
d is in a range of 0<d≦3.0.

2. The La(Fe,Si)₁₃-based hydride magnetic refrigeration material comprising multiple interstitial atoms and showing a high-temperature stability and a large magnetic entropy change according to claim 1, wherein hydrogen can exist stably in the interstices under a condition of 0 to 350° C.

3. The La(Fe,Si)₁₃-based hydride magnetic refrigeration material comprising multiple interstitial atoms and showing a high-temperature stability and a large magnetic entropy change according to claim 1, wherein, while magnetic field changes from 0 to 5 T, the magnetic entropy change value is from 5 to 50 J/kg·K, and the temperature range of phase transition is within 180-360K.

4. A method for preparing the La(Fe,Si)₁₃-based hydride magnetic refrigeration material comprising multiple interstitial atoms and showing a high-temperature stability and a large magnetic entropy change according to claim 1, comprising the steps of:
i) preparing raw materials according to a chemical formula of La₁₋ₐRₐFe_{13-b}Si_{b}X_{c}, wherein:
R is one of or any combination of the following rare-earth elements Ce, Pr, Nd, Sm, Eu, Gd, Tb, Dy, Ho, Er, Tm, Yb, Lu, Y, and Sc which satisfy the requirement for a,
a is in the ranges shown as follows:
if R is Ce, then 0<a≦0.9;
if R is Pr, Nd, then 0<a≦0.7;
if R is Sm, Eu, Gd, Tb, Dy, Ho, Er, Tm, Yb, Lu, Y, Sc, then 0<a≦0.5;
b is in a range of 0<b≦3.0;
X is one of or any combination of the elements C, B, Li, and Be which satisfy the requirement for c,
c is in a range of 0<c≦0.5;
ii) charging an arc furnace with the raw materials prepared in step i), vacuumizing the furnace, washing the chamber of the furnace with highly purified argon followed by filling the chamber with the argon to a pressure of 0.5 to 1.5 atm., striking the arc, and turning and smelting each alloy ingot repeatedly for 1 to 6 times;
iii) annealing the alloy ingot smelted in step ii) in a vacuum under a condition of 1050 to 1350° C., followed by taking the alloy ingot out and quenching it rapidly in liquid nitrogen or ice water for cooling down, so as to prepare a single-phase, NaZn₁₃-type, La₁₋ₐRₐFe_{13-b}Si_{b}X_{c} interstitial master alloy sample;
iv) crashing the master alloy La₁₋ₐRₐFe_{13-b}Si_{b}X_{c} prepared in step iii) into particles or powder, placing the particles or powder in hydrogen for annealing, so as to synthesize the hydride La₁₋ₐRₐFe_{13-b}Si_{b}X_{c}H_{d} comprising multiple interstitial atoms, wherein d is in a range of 0<d≦3.0, and wherein the content d of the hydrogen in the alloy, is controlled by adjusting the hydrogen pressure, annealing temperature, and annealing time.

5. The method according to claim 4, wherein:
in the step ii), the vacuum pressure is lower than 2×10⁻⁵ Pa, and the argon has a purity of more than 99%; and/or
in step iii), the vacuum pressure during the annealing process is lower than 1×10⁻³ Pa; and/or
in step iv), the powder produced from the singe-phase sample is irregular powder with a particle size of less than 2 mm, and the hydrogen used for annealing has a purity of more than 99%.

6. The method according to claim 4, wherein, in step i), the purities of the raw materials La, R, Fe, Si, and X are more than 99% by weight, wherein:
R is one of or any combination of the following rare-earth elements Ce, Pr, Nd, Sm, Eu, Gd, Tb, Dy, Ho, Er, Tm, Yb, Lu, Y, and Sc which satisfy the requirement for a,
a is in the ranges shown as follows:
if R is Ce, then 0<a≦0.9;
if R is Pr, Nd, then 0<a≦0.7;
if R is Sm, Eu, Gd, Tb, Dy, Ho, Er, Tm, Yb, Lu, Y, Sc, then 0<a≦0.5;
X is one of or any combination of the elements C, B, Li, and Be which satisfy the requirement for c, and
c is in a range of 0<c≦0.5.

7. The method according to claim 4, wherein Fe and X are introduced into the alloy in a form of individual element or Fe—X intermediate alloy.

8. The method according to claim 4, wherein, in step iv), the master alloy La₁₋ₐRₐFe_{13-b}Si_{b}X_{c} used for preparing La₁₋ₐRₐFe_{13-b}Si_{b}X_{c}H_{d} is a fresh master alloy.

9. The method according to claim 4, wherein a desired amount of hydrogen is obtained through a single hydrogen absorption process.

10. The method according to claim 4, wherein, in step i), the purities of the raw materials La, R, Fe, Si, and X are more than 99.9% by weight, wherein:
R is one of or any combination of the following rare-earth elements Ce, Pr, Nd, Sm, Eu, Gd, Tb, Dy, Ho, Er, Tm, Yb, Lu, Y, and Sc which satisfy the requirement for a,
a is in the ranges shown as follows:
if R is Ce, then 0<a≦0.9;
if R is Pr, Nd, then 0<a≦0.7;
if R is Sm, Eu, Gd, Tb, Dy, Ho, Er, Tm, Yb, Lu, Y, Sc, then 0<a≦0.5;
X is one of or any combination of the elements C, B, Li, and Be which satisfy the requirement for c, and
c is in a range of 0<c≦0.5.

11. The method according to claim 4, wherein, in step i), the purities of the raw materials La, R, Fe, Si, and X are more than 99.99% by weight, wherein:
R is one of or any combination of the following rare-earth elements Ce, Pr, Nd, Sm, Eu, Gd, Tb, Dy, Ho, Er, Tm, Yb, Lu, Y, and Sc which satisfy the requirement for a,
a is in the ranges shown as follows:
if R is Ce, then 0<a≦0.9;
if R is Pr, Nd, then 0<a≦0.7;
if R is Sm, Eu, Gd, Tb, Dy, Ho, Er, Tm, Yb, Lu, Y, Sc, then 0<a≦0.5;
X is one of or any combination of the elements C, B, Li, and Be which satisfy the requirement for c, and
c is in a range of 0<c≦0.5.

12. The La(Fe,Si)₁₃-based hydride magnetic refrigeration material comprising multiple interstitial atoms and showing a high-temperature stability and a large magnetic entropy change according to claim 2, wherein, while magnetic field changes from 0 to 5 T, the magnetic entropy change value is from 5 to 50 J/kg·K, and the temperature range of phase transition is within 180-360K.

13. The method according to claim 6, wherein Fe and X are introduced into the alloy in a form of individual element or Fe—X intermediate alloy.
